(19) United States
(12) Patent Application Publication
(10) Pub. No.: US 2018/0279627 A1
(43) Pub. Date: Oct. 4, 2018

(54) BELT DRIVEN SANDWICHING MACHINE

(71) Applicant: ILLINOIS TOOL WORKS INC., Glenview, IL (US)

(72) Inventors: Ankush B. Mittal, Bowling Green, OH (US); Rohan V. Patel, Troy, OH (US); Jason D. Switzer, Sidney, OH (US)

(21) Appl. No.: 15/754,732

(22) PCT Filed: Sep. 27, 2016
(86) PCT No.: PCT/US2016/053873

§ 371 Date: Feb. 23, 2018

Related U.S. Application Data
(60) Provisional application No. 62/234,210, filed on Sep. 29, 2015.

(51) Int. Cl. A21C 15/02; A21C 15/00

(52) U.S. Cl. CPC A21C 15/02; A21C 15/002

(57) ABSTRACT

A sandwiching machine includes a wafer conveying mechanism including multiple wafer conveyance rows and a pair of spaced apart belts. Each belt is positioned toward respective sides of the mechanism such that the belts are located laterally away from the wafer conveyance rows. A plurality of pusher bars extend laterally between the spaced apart belts and connected for movement therewith. Each pusher bar extends beneath a conveyance path of each wafer conveyance row and includes at least one pusher pin extending upward into the conveyance path. At least one stencil assembly extends over the wafer conveyance paths for depositing material onto wafers traveling along at least one of the wafer conveyance paths, wherein a deposit location of the stencil assembly is laterally spaced from each of the belts.

### CROSS-REFERENCES

This application claims the benefit of U.S. provisional application No. 62/234,210, filed Sep. 29, 2015, which is incorporated herein by reference.

### TECHNICAL FIELD

This application relates generally to sandwiching machines that deposit edible fillings onto wafers to form an edible sandwich product and, more particularly, to a belt drive wafer conveying arrangement for such machines.

### BACKGROUND

Systems are known that assemble sandwich type snacks by placing cream, cheese, peanut butter or other filling between two cookies or crackers or other edible wafers. Rotating stencil dies (e.g., per U.S. Pat. No. 8,683,917, which is incorporated herein by reference) are commonly used to deposit the filling onto the edible wafers as the wafers move below and past the rotating stencil die along a wafer line. The wafers are driven by pins that are driven by some type of chain drive arrangement.

FIGS. 1 and 2 depict one variation of such a chain driven sandwiching machine conveyor 10, where spaced apart carrier chains 12 are depicted along with directional arrows 14 for the chain path. The carrier chains 12 run from an idler sprocket 16 at one end and along a carrier chain rail 18 to a drive sprocket 20 at the other end, with a spring-loaded tensioner 22 provided toward the drive end of the chain path. As seen in FIG. 2, the spaced apart carrier chains 12 include pusher pins 24 connected thereto for movement with the chain, and the pusher pins generally extend upward so as to extend into a wafer path 26 (e.g., which may be defined as atop a set of thin steel wires and between a set of spaced apart guide plates). Typically, each wafer conveying row in a sandwiching machine of the type described in U.S. Pat. No. 8,683,917 includes a pair of corresponding carrier chains with pusher pins as shown in FIG. 2.

Because of the nature of the food environment, it would be desirable to provide a sandwiching machine conveying arrangement that eliminates the use of chains.

### SUMMARY

In one aspect, a sandwiching machine includes a wafer conveying mechanism including multiple wafer conveyance rows and a pair of spaced apart belts. Each belt is positioned toward respective sides of the mechanism such that the belts are located laterally away from the wafer conveyance rows. A plurality of pusher bars extend laterally between the spaced apart belts and connected for movement therewith. Each pusher bar extends beneath a conveyance path of each wafer conveyance row and includes at least one pusher pin extending upward into the conveyance path. At least one stencil assembly extends over the wafer conveyance paths for depositing material onto wafers traveling along at least one of the wafer conveyance paths, wherein a deposit location of the stencil assembly is laterally spaced from each of the belts.

In one implementation of the foregoing aspect, each wafer conveyance path includes a pair of spaced apart guide wires for supporting wafers sliding thereon as the wafers are pushed by one or more pusher pins, and a pair of spaced apart guide plates, wherein each guide wire is supported by a wire support structure that extends laterally beneath one guide plate and then back upward to the guide wire.

In one variation of the foregoing implementation, an overhead frame member is provided, and each wire support structure is connected to the overhead frame member.

In one example of the foregoing variation, each wire support structure has a fixed height dimension.

In one instance of the foregoing variation a height of the overhead frame member is adjustable to vary a height of each guide wire.

In another example of the foregoing variation, each wire support structure includes a height adjustment mechanism to adjust a height dimension of the wire support structure and enable a height of each guide wire to be adjusted.

In the case of any of the foregoing aspects, implementations, variations or instances, each belt may be spaced laterally from the conveyance path defined by a nearest of the wafer conveyance rows by at least four inches.

In another aspect, a sandwiching machine includes a wafer conveying mechanism that passes beneath at least one stencil depositor. The wafer conveyance mechanism includes at least one wafer conveyance row laterally aligned with outlet openings of the stencil depositor. A pair of spaced apart and parallel running belts is provided, each belt located laterally away from the wafer conveyance row. A plurality of pusher bars extend laterally between the spaced apart belts with one end of each pusher bar connected to one belt of the pair and an opposite end of each pusher bar connected to the other belt of the pair.

In a further aspect, a sandwiching machine includes a wafer conveying mechanism that passes transversely beneath at least one stencil die assembly. The wafer conveyance mechanism includes multiple wafer conveyance rows aligned with respective sets of outlet openings of the stencil die assembly, and a pair of spaced apart belts. Each belt is positioned toward a side rail of a mechanism frame such that the belts are located outside of a zone of the wafer conveyance rows. A plurality of pusher bars extend laterally between the spaced apart belts with one end of each pusher bar connected to one belt of the pair and an opposite end of each pusher bar connected to the other belt of the pair.

### BRIEF DESCRIPTION OF THE DRAWINGS

FIG. 1 is a perspective view of a prior art sandwiching machine conveying arrangement;

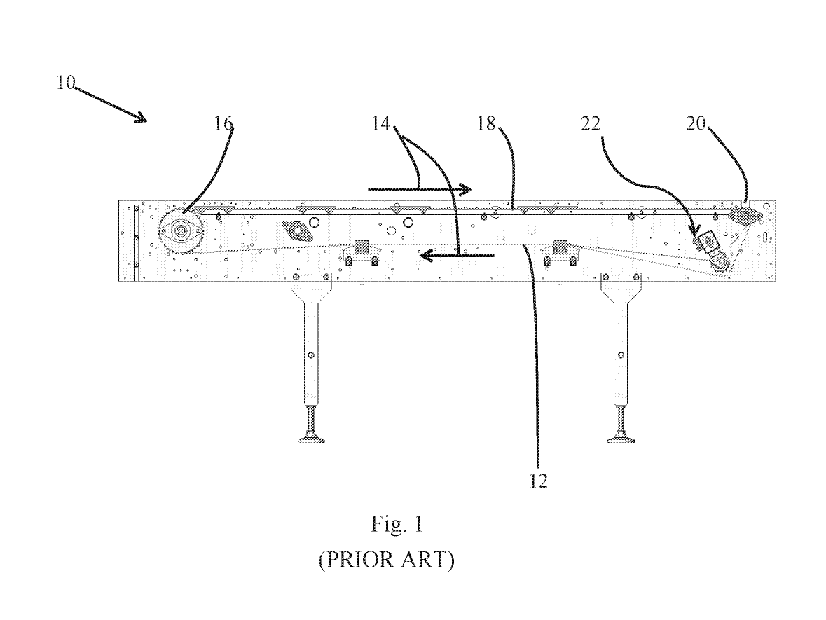

FIG. 2 is a perspective partial view of spaced apart chains of the prior art conveying arrangement;

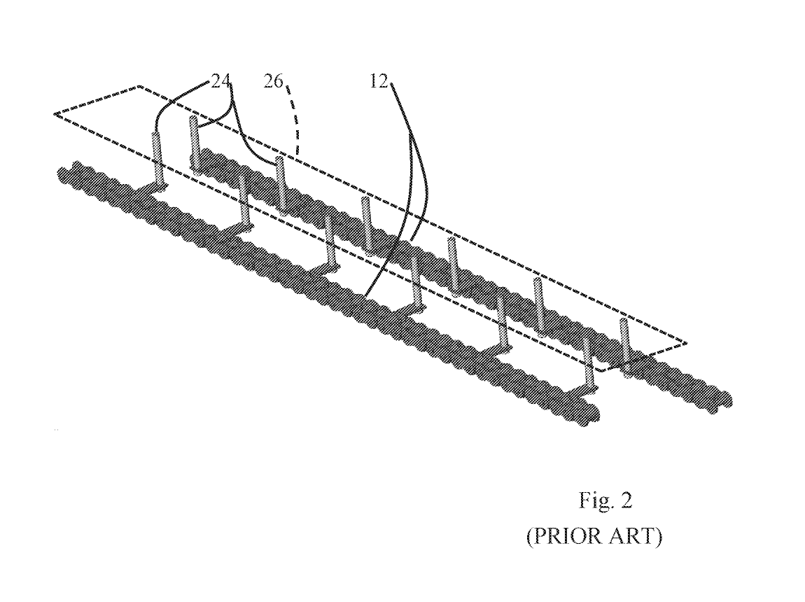

FIG. 3 is a perspective view of one embodiment of a belt driven sandwiching machine conveying arrangement;

FIG. 4 is a top plan view of the conveying arrangement of FIG. 3 with exemplary stencil depositors schematically shown;

FIG. 5 is a partial perspective view of an end portion of the conveying arrangement of FIG. 3; and

FIG. 6 is a schematic end elevation view of the conveying arrangement of FIG. 3 with exemplary conveyance paths and wire support structure shown.

### DETAILED DESCRIPTION

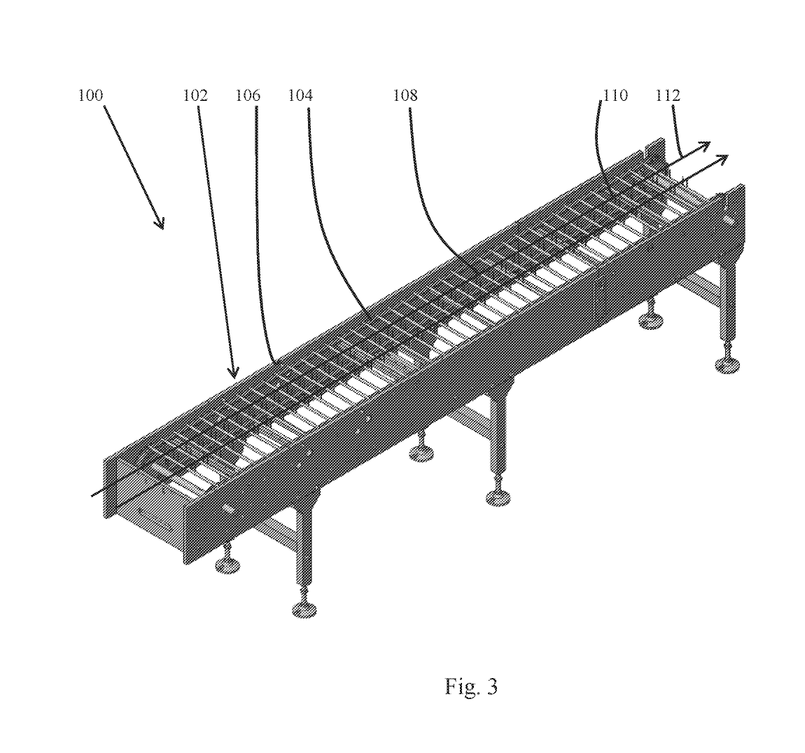

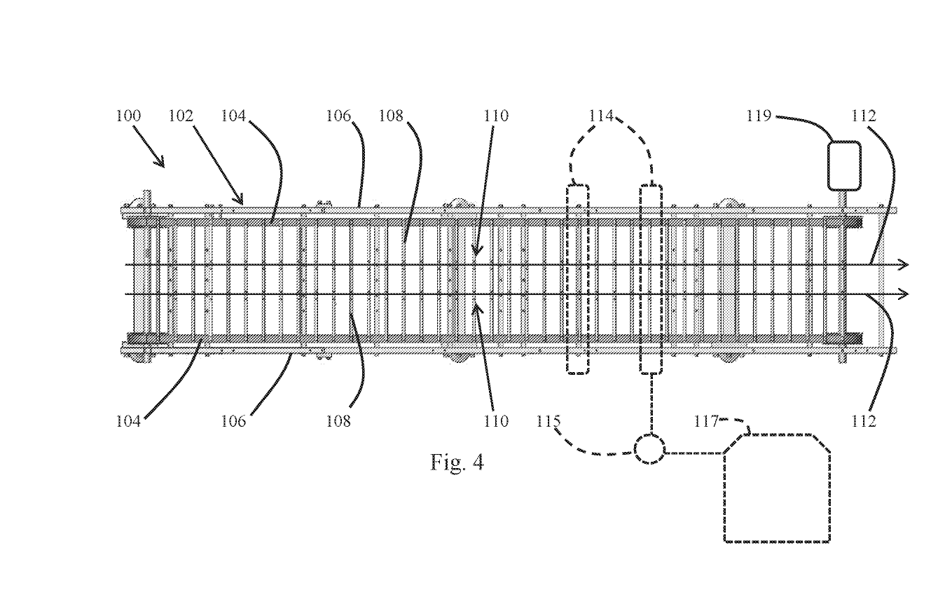

Referring to FIGS. 3-6, a belt driven sandwiching machine conveyor arrangement 100 includes a support frame 102 and a pair of spaced apart belts 104 toward the side rails 106 of the frame 102. A series of lateral pusher bars 108 are connected to and extend between the belts, with multiple pairs (here two pairs) of pusher pins 110 mounted on each bar for moving wafers along respective wafer conveyance rows, represented by arrows 112. Notably, the positioning of the belts 104 toward the side rails 106 of the machine frame results in the belts 104 being located outside of a central zone where the wafer conveyance rows 112 are located and therefore not beneath the locations where cream or other fillings are deposited (e.g., by overhead stencils represented schematically at 114) onto the traveling wafers. By way of example, the stencils 114 may typically be fed cream or other deposit material via a pump 115 from a source 117, and the stencils may rotate as cream is output from outlet openings on the stencil that are aligned with the rows 112 for depositing on passing wafers. The belts 104 may, for example, be spaced laterally from the conveyance path defined by the nearest wafer conveyance row 112 by a distance D1 of at least four inches (e.g., such as at least six inches or at least eight inches), but other variations are possible. A drive 119 for the belts is also shown in FIG. 4. A downstream arrangement may lay a second wafer atop the first after the filling is deposited on the first wafer.

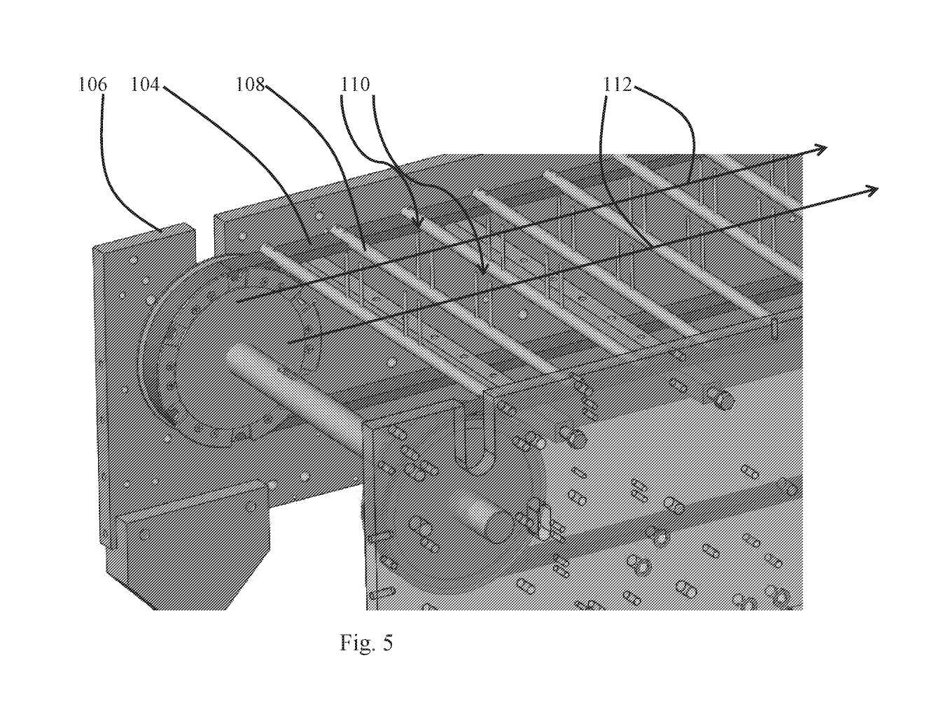

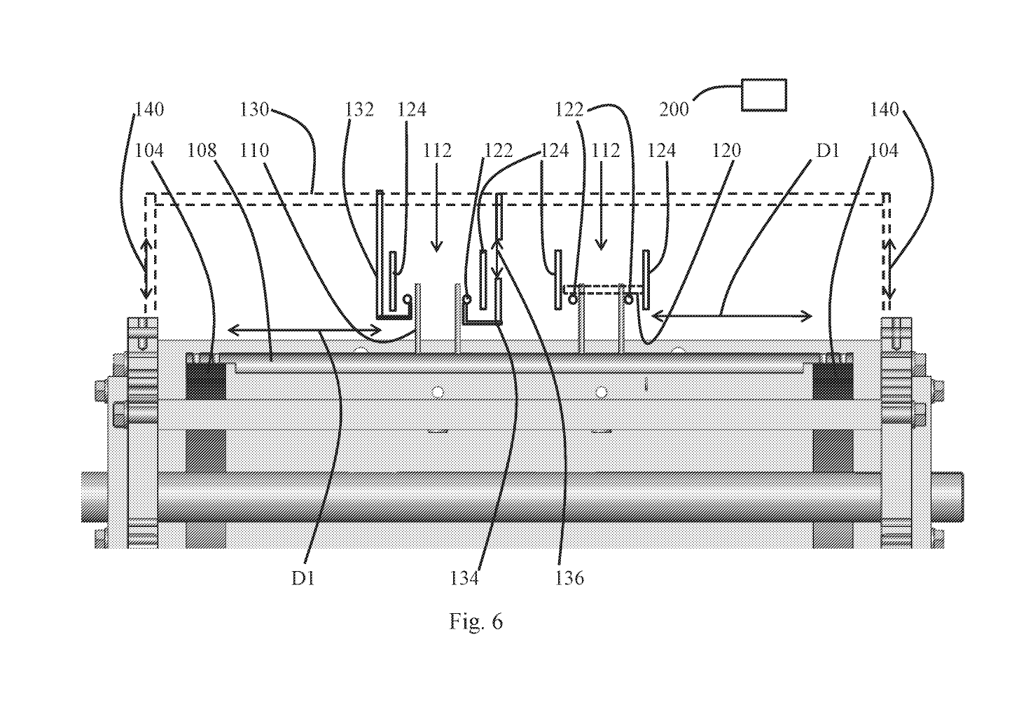

The belts 104 may be synchronously driven and formed of a polyurethane belting with steel or Kevlar cord reinforcements. In one embodiment, each belt may be an Elatech (www.elatech.com) belt utilizing EMF (Elatech Mechanical Fastening) technology. The EMF technology utilizes no exposed metal parts, which reduces noise during operation. EMF is straightforward to install and requires no field welds, making in-field service straightforward. In another embodiment, the belt may be an Elatech belt utilizing EFT (Elatech False Teeth) technology. The EFT technology is well-suited for attachment of cleats that cannot be welded onto polyurethane belts. The cleats can be used for mounting of the pusher bars and/or the ends of the pusher bars themselves may be configured as mountable cleats. This latter configuration is seen in FIGS. 5 and 6 where the end portions of the pusher bars 108 are undercut and include a set a fastener openings for mounting directly to the belt material. This arrangement enables individual pusher bars to be removed for cleaning, repair, replacement or machine modification without removing the belts or interfering with belt operation.

As indicated above, laterally extending pusher bars 108 extend between the spaced apart belts 104 (e.g., with one end of each bar connected to one belt and the opposite end of each bar connected to the other belt). Each bar 108 includes upright pusher pins 110 extending therefrom. A pair of pusher pins 110 is used in connection with each row 112 of wafer travel, where the wafers 120 (shown in dashed line form in the right row of FIG. 6) travel (e.g., by sliding) on a pair of guide wires 122 located between two side guides plates 124. The side guide plates 124 prevent lateral movement of the wafers out of the conveyance path of the row 112.

In order to adequately support the guide wires 122 and avoid any interference with the moving lateral pusher bars 108, each guide wire may, for example, be connected with an overhead support frame member or structure 130 (here represented by a dashed line) that is mounted across the top of the frame. For example, in one implementation shown on the left side of the left row 112 in FIG. 6 guide wire supports 132 of fixed height dimension may be placed at spaced apart locations along the length of the row and connected with the overhead structure 130. Here, the supports 132 extend downward along and then laterally beneath the side guide plate 124 and then upward to the guide wire 122.

On the other hand, in some implementations the ability to adjust the height of the guide wires 122 is desired. For this purpose, as shown on the right side of the left row 112 in FIG. 6, each wire 122 may have an associated support 134 with an adjustment mechanism 136 (e.g., in the form of any of a telescoping connection adjustable by threading or a linear actuator, a settable rack and pinion arrangement or other suitable adjustment means) that extends down alongside the nearest guide plate 124 of the support wire 122, under the guide plate 124 and then back up to the support wire 122. This arrangement assures that the wire supports and/or the adjustment system do not extend down into the path of the lateral pusher bars 108. Raising and lowering of the adjustment mechanism 136 is used to reposition the height of the wire 122. Multiple such adjustment members may be located along the length of each support wire to adjust the height of the support wire at various locations (e.g., particularly at locations where filling is dispensed from the stencil assemblies onto the wafers). In one example, the raising and lowering may be achieved by a manual system (e.g., manual rotation of a handle). In another example, the raising and lowering may be achieved by a powered system (e.g., via a servomotor or other prime mover, such as a linear actuator as mentioned above, under control of a controller 200 shown in FIG. 6). Alternatively, the overhead frame structure 130 itself could be raised and lowered (per adjustment mechanisms represented by arrows 140) where the fixed height dimension supports 132 are used.

Eliminating chain drives in the conveying arrangement of a sandwiching machine provides enhanced cleanability and quieter operation, while avoiding the need for lubrication. The belts may be produced of an FDA approved material suitable for food environments. Locating the belts to the sides of the wafer conveyance rows and filling deposit areas reduces material build-up on the belts.

It is to be clearly understood that the above description is intended by way of illustration and example only, is not intended to be taken by way of limitation, and that other changes and modifications are possible. For example, while a machine utilizing two wafer conveying rows is shown, machines with only one or machines with more than two are contemplated. Moreover, the number of stencil die assemblies positioned along the length of the conveying arrangement can vary depending upon the particular food product being produced and number of wafer conveying rows.

1. A sandwiching machine, comprising:
a wafer conveying mechanism including multiple wafer conveyance rows, a pair of spaced apart belts, each belt positioned toward respective sides of the mechanism such that the belts are located laterally away from the wafer conveyance rows, and a plurality of pusher bars extending laterally between the spaced apart belts and connected for movement therewith, wherein each pusher bar extends beneath a conveyance path of each wafer conveyance row and includes at least one pusher pin extending upward into the conveyance path;
at least one stencil assembly extending over the wafer conveyance paths for depositing material onto wafers traveling along at least one of the wafer conveyance paths, wherein a deposit location of the stencil assembly is laterally spaced from each of the belts.

2. The sandwiching machine of claim 1 wherein each wafer conveyance path includes a pair of spaced apart guide wires for supporting wafers sliding thereon as the wafers are pushed by one or more pusher pins, and a pair of spaced apart guide plates, wherein each guide wire is supported by a wire support structure that extends laterally beneath one guide plate and then back upward to the guide wire.

3. The sandwiching machine of claim 2, further comprising:
an overhead frame member, wherein each wire support structure is connected to the overhead frame member.

4. The sandwiching machine of claim 3 wherein each wire support structure has a fixed height dimension.

5. The sandwiching machine of claim 4 wherein a height of the overhead frame member is adjustable to vary a height of each guide wire.

6. The sandwiching machine of claim 3 wherein each wire support structure includes a height adjustment mechanism to adjust a height dimension of the wire support structure and enable a height of each guide wire to be adjusted.

7. The sandwiching machine of claim 1 wherein each belt is spaced laterally from the conveyance path defined by a nearest of the wafer conveyance rows by at least four inches.

8. A sandwiching machine, comprising:
a wafer conveying mechanism that passes beneath at least one stencil depositor, the wafer conveyance mechanism including at least one wafer conveyance row laterally aligned with outlet openings of the stencil depositor, a pair of spaced apart and parallel running belts, each belt located laterally away from the wafer conveyance row, and a plurality of pusher bars extending laterally between the spaced apart belts with one end of each pusher bar connected to one belt of the pair and an opposite end of each pusher bar connected to the other belt of the pair.

9. The sandwiching machine of claim 8 wherein each belt is spaced laterally from a conveyance path defined by the wafer conveyance row by at least four inches.

10. The sandwiching machine of claim 9 wherein the wafer conveyance path includes a pair of spaced apart guide wires for supporting wafers sliding thereon, and a pair of spaced apart guide plates, wherein at least one guide wire is supported by a wire support structure that extends laterally beneath one guide plate and then back upward to the guide wire.

11. A sandwiching machine, comprising:
a wafer conveying mechanism that passes transversely beneath at least one stencil die assembly, the wafer conveyance mechanism including multiple wafer conveyance rows aligned with respective sets of outlet openings of the stencil die assembly, a pair of spaced apart belts, each belt positioned toward a side rail of a mechanism frame such that the belts are located outside of a zone of the wafer conveyance rows, and a plurality of pusher bars extend laterally between the spaced apart belts with one end of each pusher bar connected to one belt of the pair and an opposite end of each pusher bar connected to the other belt of the pair.

12. The sandwiching machine of claim 11 wherein multiple pusher bars include upwardly projecting pins that extend into a conveyance path of at least one of the wafer conveyance rows for contacting and pushing wafers.

13. The sandwiching machine of claim 11 wherein each pusher bar includes multiple pairs of pusher pins extending upwardly therefrom, with one pair aligned with each wafer conveyance row, where wafers slidingly travel on a set of guide wires located between two side guides plates which prevent lateral movement of the wafers out of a conveyance path of the wafer conveyance row, and both pins of each pair extend upward between the set of guide wires.

14. The sandwiching machine of claim 11 further comprising:
each support wire having an associated support mechanism that extends down alongside a guide plate, laterally under the guide plate and then back up to the support wire.

15. The sandwiching machine of claim 14 wherein each support mechanism includes an associated height dimension adjustment mechanism.
